(19) United States
(12) Patent Application Publication
(10) Pub. No.: US 2026/0162589 A1
(43) Pub. Date: Jun. 11, 2026

(54) DISPLAY DEVICE AND ELECTRONIC DEVICE USING THE SAME

(71) Applicant: Samsung Display Co., Ltd., Yongin-si (KR)

(72) Inventors: Min Gyu KIM, Yongin-si (KR); Se Yun KIM, Yongin-si (KR); Jae Seob CHUNG, Yongin-si (KR); Kyung Sik JOO, Yongin-si (KR)

(73) Assignee: Samsung Display Co., Ltd., Yongin-si (KR)

(21) Appl. No.: 19/319,036

(22) Filed: Sep. 4, 2025

(30) Foreign Application Priority Data
Dec. 11, 2024 (KR) 10-2024-0183326
Apr. 1, 2025 (KR) 10-2025-0041964

(51) Int. Cl. G09G 3/20; G09G 3/3233; G09G 3/3275

(52) U.S. Cl. CPC G09G 3/2092; G09G 3/2007; G09G 3/3233; G09G 3/3275; G09G 2300/0842; G09G 2320/0626; G09G 2320/0673; G09G 2330/021

(57) ABSTRACT

A display device includes a display panel having a display area in which a plurality of pixels are arranged; a gate driver configured to drive gate lines in the display area; a data driver configured to drive data lines in the display area; a timing controller configured to align input image data according to a resolution of the display area and control driving timings of the gate driver and the data driver; and a data correction processor configured to obtain an average power consumption for image data in a preset unit of at least one frame, correct the input image data using luminance modulation data according to the average power consumption, and provide corrected image data to the data driver.

### CROSS-REFERENCING RELATED APPLICATION(S)

This application is based on and claims priority from Korean Patent Application No. 10-2024-0183326, filed on December 11, 2024 in the Korean Intellectual Property Office, and from Korean Patent Application No. 10-2025-0041964, filed on April 1, 2025, in the Korean Intellectual Property Office, the disclosures of which are herein incorporated by reference in their entireties.

### BACKGROUND

### 1. Field

The present disclosure relates to a display device and an electronic device using the same.

### 2. Description of Related Art

Various demands for display devices are ever increasing. For example, display devices are being employed by a variety of electronic devices such as smart phones, digital cameras, laptop computers, navigation devices, and smart televisions.

Display devices used in electronic devices may include flat panel display devices such as a liquid-crystal display device, a field emission display device, and an organic light-emitting display device. Among such flat-panel display devices, an organic light-emitting display device includes a light-emitting element that may emit light on its own, and each of pixels of a display panel may emit light by themselves. Accordingly, a light-emitting display device may display images without a backlight unit that supplies light to the display panel.

Recently, brightness and luminance for each grayscale level of image data have been set in advance to meet to rated power or rated power consumption for each display device, and images are displayed so as not to exceed the rated power consumption. Ranges of brightness and luminance for each grayscale level of image data may be set based on the rated power or rated power consumption at an initial setup stage or an inspection stage of display devices. Actual power consumption, however, may vary depending on specifications of the display panel for each display device, a usage environment, continuous usage time, etc. Therefore, there has been a problem that a preset power consumption is different from the actual power consumption.

### SUMMARY

One or more example embodiments of the present disclosure provide a display device that may calculate an amount of power consumed during an image display period as a display panel is driven, and may set brightness and luminance of an image to be displayed by correcting the brightness and luminance with reference to the calculated amount of power consumed, and an electronic device using the same.

One or more example embodiments of the present disclosure provide a display device that may efficiently control power consumption of the display device and image display quality by correcting and resetting a luminance value of image data with reference to the power consumption as the display panel is driven, and an electronic device using the same.

It should be noted that objects of the present disclosure are not limited to the above-mentioned object; and other objects of the present disclosure will be apparent to those skilled in the art from the following descriptions.

According to an aspect of an example embodiment of the disclosure, there is provided a display device including: a display panel having a display area in which a plurality of pixels are arranged; a gate driver configured to drive gate lines in the display area; a data driver configured to drive data lines in the display area; a timing controller configured to align input image data according to a resolution of the display area and control driving timings of the gate driver and the data driver; and a data correction processor configured to obtain an average power consumption for image data in a preset unit of at least one frame, correct the input image data using luminance modulation data according to the average power consumption, and provide corrected image data to the data driver.

According to an aspect of an example embodiment of the disclosure, there is provided a display device including: a display panel having a display area in which a plurality of pixels are arranged; a gate driver configured to drive gate lines in the display area; a data driver configured to drive data lines in the display area; a timing controller configured to align input image data according to a resolution of the display area and control driving timings of the gate driver and the data driver; and a data correction processor configured to obtain an average power consumption for image data of at least one frame and correct the input image data according to the average power consumption, wherein the data correction processor configured to obtain the average power consumption for the image data for each frame in a preset unit of at least one frame, and select luminance modulation data according to a difference between the average power consumption and a reference power consumption, and wherein the data correction processor is configured to correct grayscale values of the image data for each frame using the luminance modulation data, and provide the corrected image data for each frame to the data driver.

According to an aspect of an example embodiment of the disclosure, there is provided an electronic device including a display device, wherein the display device includes: a display panel having a display area in which a plurality of pixels are arranged; a gate driver configured to drive gate lines in the display area; a data driver configured to drive data lines in the display area; a timing controller configured to align input image data according to a resolution of the display area and control driving timings of the gate driver and the data driver; and a data correction processor configured to obtain an average power consumption for image data in a preset unit of at least one frame, correct the input image data using luminance modulation data according to the average power consumption, and provide corrected image data to the data driver.

### BRIEF DESCRIPTION OF DRAWINGS

The above and other aspects and features of the present disclosure will become more apparent by describing in detail certain example embodiments thereof with reference to the attached drawings, in which:

FIG. 1 is a plan view showing a configuration of a display device according to an embodiment of the present disclosure.

FIG. 2 is a cross-sectional view showing a side of the display device of FIG. 1 in detail.

FIG. 3 is a block diagram showing an electrical connection relationship between a display panel and drivers shown in FIGS. 1 and 2.

FIG. 4 is an equivalent circuit diagram of an example of a pixel of the display panel shown in FIG. 3.

FIG. 5 is a block diagram of a data correction processor shown in FIG. 3 according to an embodiment of the present disclosure.

FIG. 6 is a flowchart for illustrating an image data compensation process according to an embodiment of the present disclosure.

FIG. 7 is a graph for illustrating a method for selecting luminance modulation data by a luminance modulation data selection unit shown in FIG. 5.

FIG. 8 is a table showing an example of compensation threshold values for grayscale levels for each luminance modulation data stored in a compensation threshold storage unit of FIG. 5.

FIG. 9 is a block diagram of an electronic device according to an embodiment of the present disclosure.

FIG. 10 is a view showing examples of electronic devices according to embodiments of the present disclosure.

### DETAILED DESCRIPTION

The present disclosure will now be described more fully hereinafter with reference to the accompanying drawings, in which example embodiments of the disclosure are shown. This disclosure may, however, be embodied in different forms and should not be construed as limited to the embodiments set forth herein. Rather, these embodiments are provided so that this disclosure will be thorough and complete, and will filly convey the scope of the disclosure to those skilled in the art.

It will also be understood that when a layer is referred to as being “on” another layer or substrate, it may be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Each of the features of the various embodiments of the present disclosure may be combined or combined with each other, in part or in whole, and technically various interlocking and driving are possible. Each embodiment may be implemented independently of each other or may be implemented together in an association.

Hereinafter, embodiments of the present disclosure will be described with reference to the accompanying drawings.

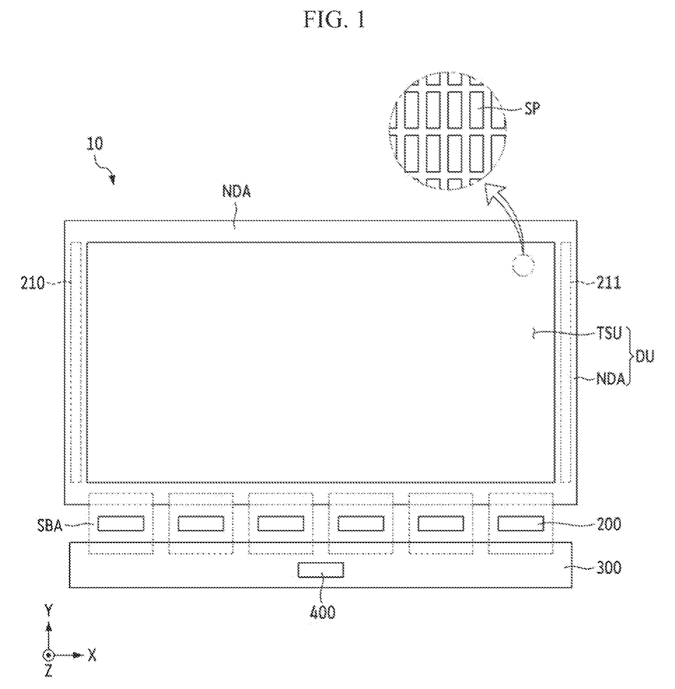

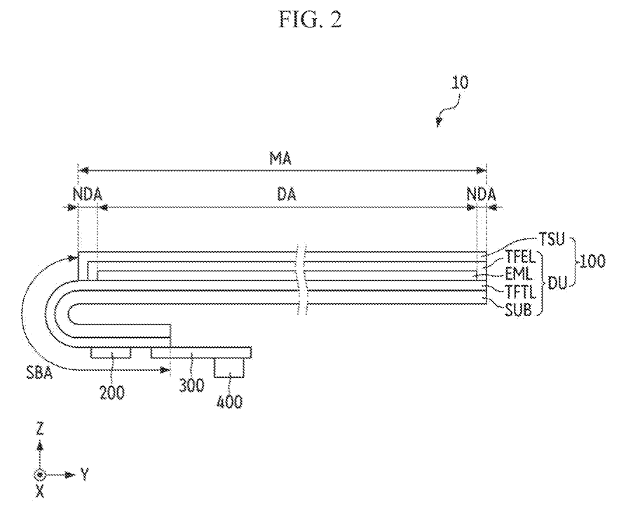

FIG. 1 is a plan view showing a configuration of a display device according to an embodiment of the present disclosure. FIG. 2 is a cross-sectional view showing a side of the display device of FIG. 1 in detail.

Referring to FIGS. 1 and 2, a display device 10 according to an embodiment of the present disclosure may be employed by portable electronic devices such as, for example but not limited to, a tablet PC, a portable multimedia player (PMP), a navigation device, an ultra mobile PC (UMPC), an electronic notebook, an electronic book, a mobile phone, a smart phone, and a mobile communications terminal. For example, the display device 10 may be employed as a display module of an electronic device such as a television, a laptop computer, a monitor, an electronic billboard, and an Internet of Things (IOT) device.

In the following description, an organic light-emitting display device will be described as an example of the display device 10 according to an embodiment of the present disclosure. The organic light-emitting display device will be simply referred to as the display device 10 unless it is necessary to distinguish between them. It is, however, to be understood that the embodiments of the present disclosure are not limited to the organic light-emitting display device, and one of the above-listed display devices or any other display device known in the art may be employed as the display device 10 without departing from the scope of the present disclosure.

According to an embodiment of the present disclosure, the display device 10 may have various shapes such as, for example but not limited to, a rectangular shape, a square shape, a circular shape, an elliptical shape or a quadrangular shape when viewed from above. For example, when the display device 10 is employed in a mobile device such as a tablet PC, the display device 10 may have a rectangular shape and longer sides thereof may extend in a horizontal direction. It should be understood, however, that the present disclosure is not limited thereto. The longer sides may extend in a vertical direction. Alternatively, the display device 10 may be installed rotatably and the longer sides may be variably positioned in the horizontal direction or the vertical direction.

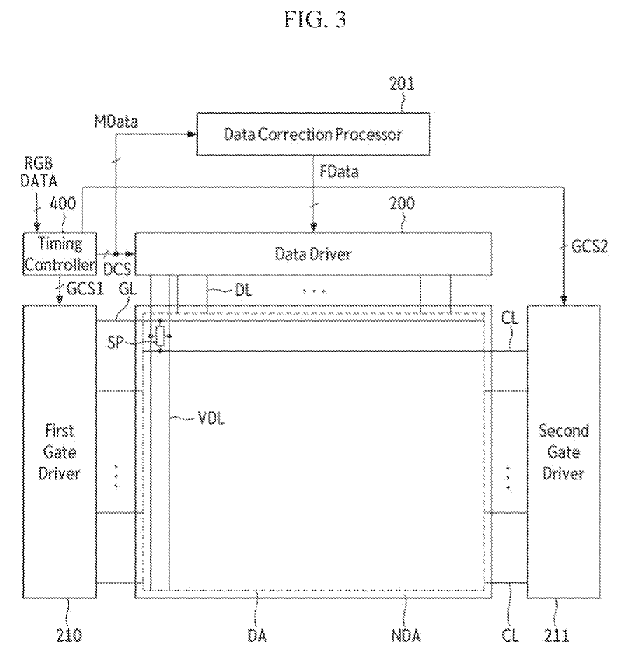

The display device 10 may include a display panel 100, a touch sensing unit TSU, one or more gate drivers 210 and 211, a data driver 200, a circuit board 300, a timing controller 400, and a data correction processor 201 (see FIG. 3).

The display panel 100 of the display device 10 may include a display unit DU configured to display an image, and the touch sensing unit TSU disposed on the display panel 100 to sense a touch by an object such as, for example, a part of a human body and/or an electronic pen.

The display unit DU of the display panel 100 may include a substrate SUB, a thin film transistor layer TFTL, a light emitting element layer EML, and a thin film encapsulation layer TFE.

The display unit DU of the display panel 100 may include a plurality of pixels SP each representing a corresponding color, for example, red, green or blue, and may display an image through the plurality of pixels SP. The display unit DU may include the plurality of pixels SP each representing, for example, red, green, blue or white. In an embodiment, three pixels SP configured to display red, green and blue lights, respectively, may be sorted into a single unit pixel. Alternatively, four pixels SP configured to display red, green, blue and white, respectively, may be sorted into a single unit pixel. However, these are merely examples and embodiments are not limited thereto.

The touch sensing unit TSU may be mounted on a front surface of the display panel 100 or formed integrally with the display panel 100. The touch sensing unit TSU may include a plurality of touch electrodes to sense a user’s touch by capacitive sensing using the plurality of touch electrodes or the like.

The one or more scan drivers 210 and 211 may provide gate scan signals to the pixels SP in each horizontal line through respective gate lines of the display unit DU based on a gate control signal from the timing controller 400. The one or more scan drivers 210 and 211 may sequentially provide the gate scan signals to the gate lines for respective horizontal lines and drive the pixels SP arranged in each horizontal line to sequentially charge data voltage. In addition, the one or more scan drivers 210 and 211 may provide emission drive signals to emission control lines for the respective horizontal lines of the display unit DU based on the gate control signal. The one or more scan drivers 210 and 211 may sequentially provide the emission drive signals to the emission control lines and control pixel driving voltages of the pixels SP in each horizontal line to be output to light-emitting elements.

The data driver 200 may include a plurality of data driver integrated circuits. The data driver 200 may output data voltages according to corrected image data to the pixels SP of the display unit DU based on a data drive control signal from the timing controller 400. The data driver integrated circuits may provide data voltages to data lines DL connected to the pixels SP in each horizontal line every horizontal cycle.

The timing controller 400 may operate as a main processor or may be formed integrally with the main processor. Accordingly, the timing controller 400 may control overall functions of the display device 10. For example, the timing controller 400 may sort image data input from a graphics card or an external graphics system according to a resolution of the display panel 100 and provide the sorted image data to the data correction processor 201 (see FIG. 3). In addition, the timing controller 400 may control timing of outputting gate scan signals for each of the gate drivers 210 and 211 and simultaneously control timing of outputting data voltages by the data driver 200. In doing so, the timing controller 400 may generate data control signals to control the timing of outputting data voltage by the data driver integrated circuits included in the data driver 200. The timing controller 400 may detect touch coordinate information included in touch data of the touch sensing unit TSU and generate digital video data according to the touch coordinate information. In addition, the timing controller 400 may run an application indicated by an icon displayed on the user’s touch coordinates. For another example, the timing controller 400 may receive coordinate data from an electronic pen to determine the touch coordinates of the electronic pen, and may generate digital video data according to the touch coordinates or may run an application indicated by an icon displayed at the touch coordinates of the electronic pen.

Referring to FIG. 2 in conjunction with FIG. 1, the display panel 100 may be divided into a main area MA and a subsidiary area SBA. The main area MA may include a display area DA where the pixels SP configured to display an image are disposed, and a non-display area NDA located around the display area DA. In the display area DA, light may be emitted from an emission area or an opening area of each pixel SP to display an image. To this end, each of the pixels SP in the display device DA may include a pixel circuit including switching elements, a pixel-defining layer that defines the emission area or the opening area, and a self-light-emitting element.

The non-display area NDA may be an edge or an outer area of the display area DA. The non-display area NDA may be defined as the edge area of the main area MA of the display panel 100. In the non-display area NDA, the one or more scan drivers 210 and 211, the data driver 200, and fan-out lines (not shown) that connect the timing controller 400 with the display area DA may be formed.

The subsidiary area SBA may extend from one side of the main area MA. The subsidiary area SUB may be formed as a film including a flexible material that may be bent, folded, or rolled. For example, when the subsidiary area SBA is bent, the subsidiary area SBA may overlap the main area MA in a thickness direction (z-axis direction). The subsidiary area SBA may include pads connected to the data driver 200 and the circuit board 300. Optionally, the subsidiary area SBA may be eliminated, and the data driver 200 and the pads may be disposed in the non-display area NDA.

The data driver 200 may include a plurality of integrated circuits (IC) and may be attached to the display panel 100 by, for example, a chip-on-glass (COG) technique, a chip-on-plastic (COP) technique, or ultrasonic bonding. For example, the data driver 200 may be disposed in the subsidiary area SBA and may overlap with the main area MA in the thickness direction (z-axis direction) when the subsidiary area SBA is bent. For another example, the data driver 200 may be mounted on the circuit board 300.

The circuit board 300 may be electrically connected to the pads of the display panel 100 by an anisotropic conductive film (ACF). To this end, lead lines of the circuit board 300 may be electrically connected to the pads of the display panel 100. The circuit board 300 may be, for example, a flexible printed circuit board (FPCB), a printed circuit board (PCB), or a flexible film such as a chip-on-film (COF).

The timing controller 400 and the data correction processor 201 (see FIG. 3) may be mounted on the circuit board 300. The timing controller 400 and the data correction processor 201 may be formed as an integrated circuit (IC) such as a microprocessor. In particular, the timing controller 400 and the data correction processor may be formed as an integrated circuit (IC) in a form of a single chip.

FIG. 3 is a block diagram showing an electrical connection relationship between the display panel and the drivers shown in FIGS. 1 and 2.

Referring to FIG. 3, a plurality of pixels SP may be arranged in a matrix in the display area DA. In addition, in the display area DA and the non-display area NDA, a plurality of gate lines GL connected to the pixels SP in each horizontal line and a plurality of data lines DL connected to the pixels SP for each vertical line may be arranged.

The plurality of gate lines GL may extend in an x-axis direction that is the horizontal direction and may be spaced apart from one another in the vertical direction crossing the horizontal direction. The plurality of gate lines GL may be equally spaced apart from one another in the vertical direction.

The one or more gate drivers 210 and 211, e.g., a first gate driver 210 may sequentially provide gate scan signals to the pixels SP in each horizontal line through respective gate lines GL based on a first gate control signal GCS1 from the timing controller 400. The gate lines GL may sequentially provide the pixels SP in each horizontal line with the gate scan signals generated sequentially for each horizontal cycle from the first scan driver 210.

The one or more gate drivers 210 and 211, e.g., a second gate driver 211 may sequentially provide emission control scan signals to the pixels SP in each horizontal line through respective emission control lines CL based on a second gate control signal GCS2 from the timing controller 400. The emission control lines CL may sequentially provide the pixels SP in each horizontal line with the emission control signals generated sequentially for each horizontal cycle from the second scan driver 211.

In the display area DA and the non-display area NDA, a plurality of data lines DL connected to the pixels SP for each vertical line may be arranged in each vertical line, and a plurality of data lines DL may be electrically connected to the data driver 200. The data voltage may determine luminance of light emitted from each of the plurality of pixels SP.

The timing controller 400 may receive timing synchronization signals through an external graphics system, etc., and also sequentially receive image data RGB DATA for each of the pixels SP. The timing controller 400 may sequentially sort the image data RGB DATA for each of the pixels SP that is sequentially input in a unit of at least one frame.

The timing controller 400 may control operation timing of the data driver 200 by generating a data drive control signal DCS based on timing synchronization signals. In doing so, the timing controller 400 may sort the image data RGB DATA input from a graphics card or an external graphics system according to the resolution of the display panel 100 in a unit of at least one frame and provide the sorted image data to the data correction processor 201. In addition, the timing controller 400 may control the operation timing of the data driver 200 by providing the data drive control signals DCS to the data driver 200. In addition, the timing controller 400 may generate first and second gate drive control signals GCS1 and GCS2 and respectively provide the first and second gate drive control signals GCS1 and GCS2 to the first and second gate drivers 210 and 211, thereby controlling operation timing of each of the first and second gate drivers 210 and 211.

The data correction processor 201 may sequentially store image data MData aligned in a unit of at least one frame from the timing controller 400, and calculate average power consumption for image data of at least one frame in a unit of at least one frame period set in advance (or image data in a preset unit of at least one frame period). For example, the data correction processor 201 may sequentially store 10-frame image data in a unit of 10 frames, and may calculate power consumption for the 10-frame image data and average power consumption for the 10-frame image data.

The data correction processor 201 may compare the average power consumption calculated in a unit of at least one frame set in advance with reference power consumption preset for each display device, and select a gamma compensation curve and luminance modulation data associated with the gamma compensation curve based on a difference in power consumption between the average power consumption and the reference power consumption. Then, the data correction processor 201 may extract grayscale compensation threshold values according to the luminance modulation data, to correct the grayscale levels of the image data for each frame using the grayscale compensation threshold values.

The data correction processor 201 may sequentially provide corrected image data FData for each frame, which has been corrected using the grayscale compensation threshold values, to the data driver 200 at least for each horizontal line. In doing so, the timing controller 400 may generate the data drive control signals DCS to control the timing of outputting data voltage by the data driver integrated circuits included in the data driver 200. Accordingly, the data driver 200 may generate analog data voltages associated with the grayscale values of the corrected image data FData for each frame, and provide the analog data voltages to each of the pixels SP under control of the timing controller 400 for outputting the analog data voltage.

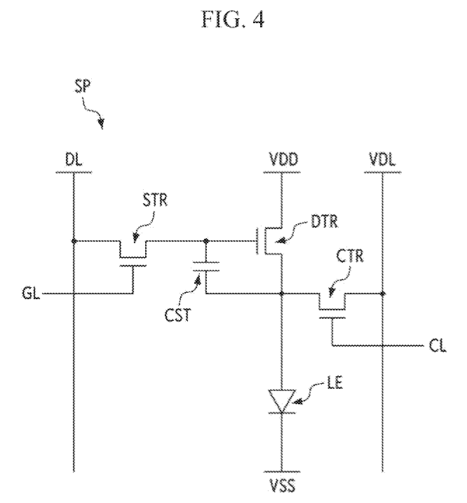

FIG. 4 is an equivalent circuit diagram of an example of a pixel of the display panel shown in FIG. 3.

Referring to FIG. 4, each of the pixels SP may include two transistors, a first transistor STR and a driving transistor DTR, and a storage capacitor CST for allowing a light-emitting element LE to emit light, and a compensation transistor CTR for transmitting a pixel driving voltage provided to the light-emitting element LE to a voltage detection line VDL.

The driving transistor DTR may adjust an amount of electric current flowing to the light-emitting element LE from a first supply voltage line VDD from which a first supply voltage is applied according to a voltage difference between a gate electrode and a source electrode of the driving transistor DTR. The gate electrode of the driving transistor DTR may be connected to a first electrode of the first transistor STR, a first electrode of the driving transistor DTR may be connected to the first supply voltage line VDD from which the first supply voltage is applied, and a second electrode of the driving transistor DTR may be connected to a first electrode of the light-emitting element LE.

The first transistor STR1 may be turned on by a gate scan signal of the gate line GL to apply the data voltage of the data line DL to the gate electrode of the driving transistor DTR. The gate electrode of the first transistor STR1 may be connected to the gate line GL, a first electrode of the first transistor STR1 may be connected to the gate electrode of the driving transistor DTR, and a second electrode of the first transistor STR1 may be connected to the data line DL.

The storage capacitor CST may be between the gate electrode and the second electrode of the driving transistor DTR. The storage capacitor CST may store a voltage difference between the gate voltage and the source voltage or the drain voltage of the driving transistor DTR.

The compensation transistor CTR may be turned on by a compensation gate scan signal of a compensation gate line CL to electrically connect the first electrode of the light-emitting element LE with one of voltage detection lines VDL. The pixel driving voltage may be supplied to the data driver 200 through the voltage detection line VDL.

The first transistor STR1, the driving transistor DTR and the compensation transistor CTR may be thin-film transistors. Although the first transistor STR1, the driving transistor DTR and the compensation transistor CTR are illustrated as n-type metal oxide semiconductor field effect transistors (MOSFETs) in an example embodiment shown in FIG. 4, it is to be noted that the present disclosure is not limited thereto. For example, the first transistor STR1, the driving transistor DTR and the compensation transistor CTR may be p-type MOSFETs, or some may be implemented as n-type MOSFETs and the others may be implemented as p-type MOSFETs.

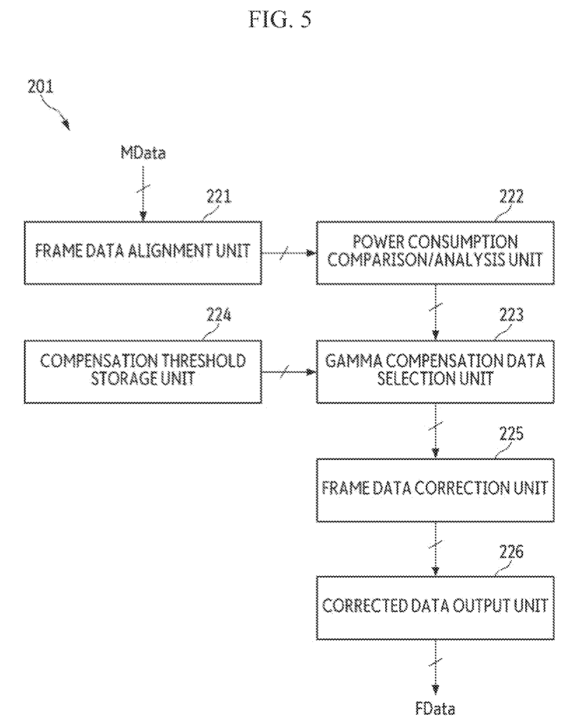

FIG. 5 is a block diagram of the data correction processor shown in FIG. 3 according to an embodiment of the present disclosure.

Referring to FIG. 5, the data correction processor 201 may include a frame data alignment unit 221, a power consumption comparison/analysis unit 222, a luminance modulation data selection unit 223, a compensation threshold storage unit 224, a frame data correction unit 225, and a corrected data output unit 226.

The frame data alignment unit 221 may sequentially align image data MData sequentially input from the timing controller 400 in a unit of at least one frame set in advance, and store the aligned image data. For example, the frame data alignment unit 221 may align the image data MData sequentially input from the timing controller 400 in a unit of preset frame(s) such as 60, 120, 180, 240, ... 6,000 frames, and may store the aligned image data in a built-in memory or an external memory.

The power consumption comparison/analysis unit 222 may calculate the average power consumption for each frame of the image data that is stored in a built-in memory or an external memory in a unit of preset frame(s). Then, the power consumption comparison/analysis unit 222 may compare the average power consumption calculated in a unit of at least one frame for the image data with power consumption per a reference period that is preset for each display device and analyze a comparison result.

For example, the power consumption comparison/analysis unit 222 may calculate the power consumption for each frame of the image data stored for preset frames such as 60, 120, 180, 240, ... 6,000 frames, and the average power consumption for the stored image data in a unit of the preset frames.

The power consumption comparison/analysis unit 222 may calculate in real time or in a unit of preset periods a difference between the power consumption per frame calculated during an image display period and the power consumption per the reference period, or a difference between the average power consumption and the power consumption per the reference period. The difference in power consumption may be transmitted to the luminance modulation data selection unit 223.

The power consumption per preset reference period may refer to a reference power consumption preset via inspection and evaluation processes before fabrication of a display device is completed, and may include power consumption for displaying a maximum luminance per a display period of the display panel 100. For example, the power consumption per the reference period may include the power consumption for at least one frame during which the display panel 100 of the display device displays an image at maximum luminance. Accordingly, the power consumption per a reference period may include the power consumption per preset frames (e.g., 60, 120, 180, 240, ... 6,000 frames) for displaying images at the maximum luminance.

The luminance modulation data selection unit 223 may select the gamma compensation curve and luminance modulation data associated with the gamma compensation curve according to the difference between the power consumption per frame calculated during an image display period and the power consumption per the reference period, or the difference between the average power consumption and the power consumption per the reference period. Then, the luminance modulation data selection unit 223 may extract the grayscale compensation threshold values according to the selected luminance modulation data from the compensation threshold storage unit 224 and output the extracted grayscale compensation threshold values to the frame data correction unit 225.

The frame data correction unit 225 may receive the grayscale compensation threshold values according to the luminance modulation data from the luminance modulation data selection unit 223. Then, the frame data correction unit 225 may correct the grayscale values for each frame of the image data stored in the frame data alignment unit 221 using the grayscale compensation threshold values provided from the luminance modulation data selection unit 223 to generate corrected image data for each frame.

For example, the frame data correction unit 225 may correct the grayscale values for each frame of the image data by applying the grayscale compensation threshold values to the grayscale values of the image data for each frame using a calculation formula (e.g., addition and/or multiplication). The frame data correction unit 225 may sequentially provide the corrected data output unit 226 with the corrected image data for each frame that have corrected grayscale values.

The corrected data output unit 226 may sequentially store the corrected image data from the frame data correction unit 225 in a unit of at least one frame, and sequentially provide the corrected image data to the data driver 200 in at least one horizontal line using a line memory or a buffer.

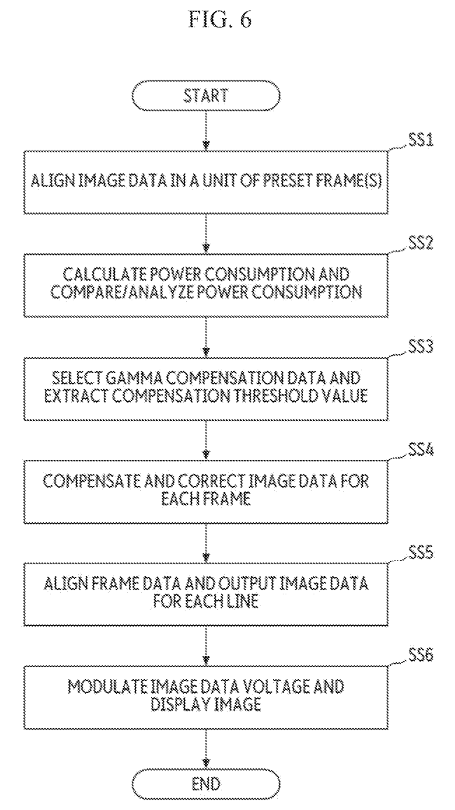

FIG. 6 is a flowchart for illustrating an image data compensation process according to an embodiment of the present disclosure.

Referring to FIGS. 5 and 6, the frame data alignment unit 221 of the data correction processor 201 may sequentially align, in a unit of at least one frame, the image data MData inputted from the timing controller 400 per every horizontal line or every frame, and store the aligned image data in a built-in memory or an external memory. For example, the frame data alignment unit 221 may align the image data MData from the timing controller 400 in a unit of preset frame(s) such as 60, 120, 180, 240, 300, 360, 420, 480, 540, 600, ... 6,000 frames, and may store the aligned image data in the memory (step SS1).

The power consumption comparison/analysis unit 222 may calculate the average power consumption for the image data for each frame that is stored in a built-in memory or an external memory in a unit of preset frames. Specifically, the power consumption comparison/analysis unit 222 may calculate a maximum grayscale value frequency, a minimum grayscale value frequency, and the average grayscale value for the image data for each frame stored for preset frames such as 60, 120, 180, 240, 300, 360, 420, 480, 540, 600, ... 6,000 frames. Then, the power consumption comparison/analysis unit 222 may derive the power consumption associated with the calculated maximum and minimum grayscale value frequencies and average grayscale values through a calculation formula or a look-up table. In doing so, the power consumption comparison/analysis unit 222 may calculate the power consumption per at least one frame, and/or may calculate the power consumption for the image data of frames for a preset reference period (e.g., the stored image data in a unit of preset frames).

The power consumption comparison/analysis unit 222 may compare the average power consumption calculated in a unit of at least one frame with the power consumption per a reference period preset for each display device, and calculate the difference between the power consumption per frame for the image data calculated in real time and the power consumption per the reference period, or the difference between the average power consumption in a unit of preset frames for the image data and the power consumption per the reference period. The results of calculating the difference in power consumption are transmitted to the luminance modulation data selection unit 223 (step SS2).

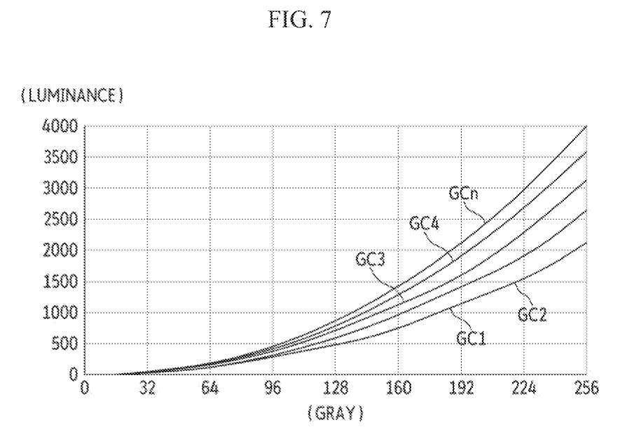

FIG. 7 is a graph for illustrating a method for selecting luminance modulation data by the luminance modulation data selection unit shown in FIG. 5.

Referring to FIG. 7, the luminance modulation data selection unit 223 may select or maintain a predetermined current reference gamma compensation curve, e.g., an n^{th} gamma compensation curve GCn, or select one of gamma compensation curves GC1 to GC4 based on which a maximum luminance value is adjusted to be lower, according to the difference in power consumption calculated from the power consumption comparison/analysis unit 222. Then, the luminance modulation data selection unit 223 may extract the grayscale compensation threshold values for the selected gamma compensation curve from the compensation threshold storage unit 224.

The luminance modulation data selection unit 223 may select or maintain the reference gamma compensation curve (e.g., the n^{th} gamma compensation curve GCn) if the difference in power consumption calculated by the power consumption comparison/analysis unit 222 is calculated to be within a predetermined reference power consumption or maintained. Accordingly, if the difference in power consumption is maintained below the reference value, the luminance modulation data selection unit 223 may select the reference gamma compensation curve (e.g., the n^{th} gamma compensation curve GCn) and luminance modulation data according to the reference gamma compensation curve, and extract grayscale compensation threshold values according to the luminance modulation data from the compensation threshold storage unit 224 to output the extracted grayscale compensation threshold values to the frame data correction unit 225.

The frame data correction unit 225 may receive the reference gamma compensation curve the grayscale compensation threshold values according to the luminance modulation data from the luminance modulation data selection unit 223. Then, the frame data correction unit 225 may correct the grayscale values for each frame of the image data stored in the frame data alignment unit 221 using the grayscale compensation threshold values provided from the luminance modulation data selection unit 223 to generate corrected image data for each frame.

The correction data output unit 226 may sequentially store the correction image data from the frame data correction unit 225 in a unit of at least one frame, and sequentially provide the correction image data to the data driver 200 per at least one horizontal line using a line memory or a buffer.

On the other hand, if the difference in power consumption calculated by the power consumption comparison/analysis unit 222 is calculated to be greater than the predetermined reference power consumption or becomes greater stepwise, the luminance modulation data selection unit 223 may select one of a plurality of first to fourth gamma compensation curves GC1 to GC4 set with grayscale compensation threshold values, by which the maximum luminance value and gamma compensation voltage values become lower.

For example, if the difference in power consumption becomes greater than the predetermined reference power consumption by one step, the luminance modulation data selection unit 223 may select the fourth gamma compensation curve GC4 set with the grayscale compensation threshold values, by which the maximum luminance value and the gamma compensation voltage values are lowered by one step.

In addition, if the difference in power consumption becomes greater than the predetermined reference power consumption by two steps, then the luminance modulation data selection unit 223 may select a third gamma compensation curve GC3 set with the grayscale compensation threshold values, by which the maximum luminance value and the gamma compensation voltage values are lowered by two steps.

In addition, if the difference in power consumption becomes greater than the predetermined reference power consumption by three steps, then the luminance modulation data selection unit 223 may select a second gamma compensation curve GC2 set with the grayscale compensation threshold values, by which the maximum luminance value and the gamma compensation voltage values are lowered by three steps.

In addition, if the difference in power consumption becomes greater than the predetermined reference power consumption by four steps, then the luminance modulation data selection unit 223 may select the first gamma compensation curve GC1 set with the grayscale compensation threshold values, by which the maximum luminance value and the gamma compensation voltage values are lowered by four steps.

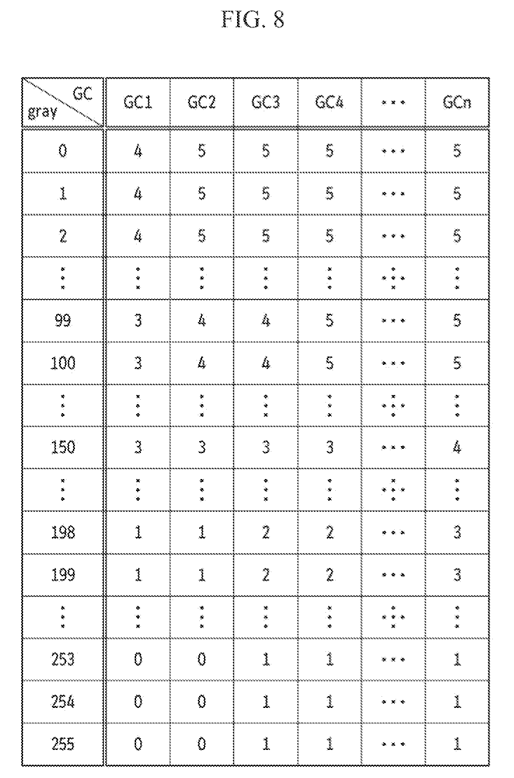

FIG. 8 is a table showing an example of grayscale compensation threshold values for grayscale levels for each luminance modulation data stored in the compensation threshold storage unit of FIG. 5.

Referring to FIGS. 7 and 8, grayscale gamma compensation voltage values and the grayscale compensation threshold values including the grayscale gamma compensation voltage values may be set in advance to be variably increased or decreased according to the maximum luminance value and a curvature of each of the gamma compensation curves GC1 to GCn.

The maximum luminance value may be set differently depending on each of the gamma compensation curves GC1 to GCn, and the grayscale compensation threshold values may be set differently for the luminance modulation data for each grayscale level according to each of the gamma compensation curves GC1 to GCn. The grayscale compensation threshold values may vary gradually within the range of 0.0 to 5.0.

The luminance modulation data selection unit 223 may extract the grayscale compensation threshold values according to the selected one of the gamma compensation curves GC1 to GCn (or gamma compensation data) and the luminance modulation data from the compensation threshold storage unit 224 to output the extracted grayscale compensation threshold values to the frame data correction unit 225 (step SS3).

The frame data correction unit 225 may receive the grayscale compensation threshold values according to the luminance modulation data from the luminance modulation data selection unit 223. Then, the frame data correction unit 225 may correct the grayscale values for each frame of the image data stored in the frame data alignment unit 221 using the grayscale compensation threshold values provided from the luminance modulation data selection unit 223 to generate corrected image data for each frame.

For example, the frame data correction unit 225 may correct the grayscale values for each frame of the image data by applying the grayscale compensation threshold values to the grayscale values for each frame of the image data using a calculation formula (e.g., addition or multiplication). The frame data correction unit 225 may sequentially provide the corrected data output unit 226 with the corrected image data for each frame with corrected grayscale values (step SS4).

The correction data output unit 226 sequentially stores the correction image data from the frame data correction unit 225 in a unit of at least one frame, and sequentially provide the correction image data to the data driver 200 per at least one horizontal line using a line memory or a buffer (step SS5).

The timing controller 400 may generate the data drive control signals DCS to control the timing of outputting data voltage by the data driver integrated circuits included in the data driver 200. Accordingly, the data driver 200 may generate analog data voltages associated with the grayscale values of the corrected image data FData for each frame, and provide the data voltages to each of the pixels SP under control of the timing controller 400 for outputting the data voltages (step SS6).

In this manner, the timing controller 400 and the data correction processor 201 according to an embodiment may adjust the brightness and luminance of the displayed images with reference to the amount of power consumed during the image display period. The timing controller 400 and the data correction processor 201 may correct the luminance value of the image data with reference to the power consumption calculated during an actual image display period, such as an inspection period of the display device to display the images, thereby further improving display quality, such as brightness and luminance, of images having low power consumption characteristics.

The display device 10 according to an embodiment may be applied to a variety of electronic devices. An electronic device according to an embodiment may include the display device 10 described above, and may further include a module or device having additional features in addition to the display device 10.

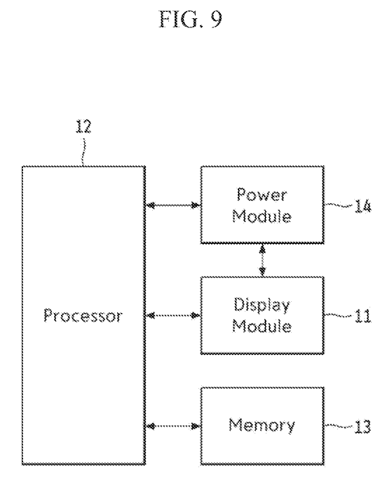

FIG. 9 is a block diagram of an electronic device according to an embodiment of the present disclosure.

Referring to FIG. 9, an electronic device 110 according to an embodiment of the present disclosure may include a display module 11 that is implemented as the display device 10 (see e.g., FIG. 1) or may include the display module 11 that is implemented as the display device 10, a processor 12, a memory 13, and a power module 14.

Specifically, the processor 12 may include at least one of, for example, a central processing unit (CPU), an application processor (AP), a graphic processing unit (GPU), a communication processor (CP), an image signal processor (ISP), and a controller. According to an embodiment of the present disclosure, the processor 12 may be divided into two or more elements in terms of functionality or structure. For example, the processor 12 may include a main processor in a form of a first drive chip including a central processing unit, and a secondary processor in a form of a second drive chip including a controller that receives an image signal from the main processor and process the image signal to meet interface specifications of the display module 11.

The memory 13 may include at least one of a non-volatile memory and a volatile memory. The memory 13 may store data information required for operation of the processor 12 and/or the display module 11. When the processor 12 executes an application stored in the memory 13, an image data signal and/or an input control signal may be transmitted to the display module 11. The display module 11 may process the received signal and output image information through a display screen.

The power module 14 may include a power supply module such as a power adapter and a battery device, and a power conversion module that converts the power supplied by the power supply module to generate power required for operation of the electronic device 10. Power conversion by the power conversion module may include, but is not limited to, DC-DC conversion, AC-DC conversion, and DC-AC conversion. As another example, the power module 14 may be located in the display device 10 and may supply power to the processor 12 and the memory 13 in the electronic device 11 other than the display device 10. It should be understood, however, that the embodiments of the present disclosure are not limited thereto.

At least one of the elements of the electronic device 110 described above may be included in the display device 10 according to the embodiments described above. In addition, some of individual modules functioning as a single module may be included in the display device 10 while some others may be provided separately from the display device 10. For example, the display device 10 may include the display module 110, and the processor 12, the memory 13 and the power module 14 may be provided as other devices inside the electronic device 11 than the display device 10.

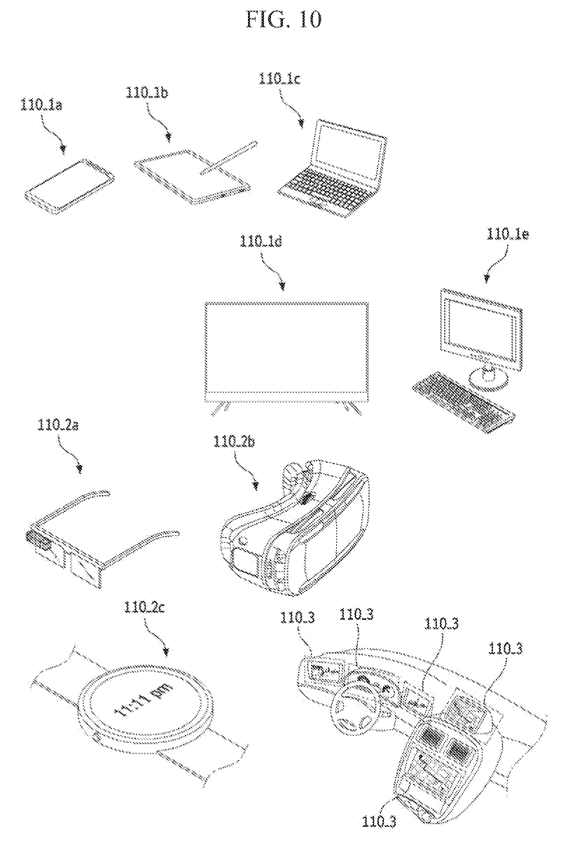

FIG. 10 is a view showing examples of electronic devices according to embodiments of the present disclosure.

Referring to FIG. 10, various examples of an electronic device 110 employing the display device 10 according to the embodiments may include not only image display electronic devices such as a smart phone 110_1a, a tablet PC 110_1b, a laptop computer 110_1c, a TV 110_1d and a desktop monitor 110_1e, but also wearable electronic devices including display modules such as smart glasses 110_2a, a head-mounted display 110_2b and a smart watch 110_2c, and electronic devices for vehicles 110_3 including display modules such as a center information display (CID) placed on the dashboard, the center fascia and the dashboard of a vehicle, and a room mirror display.

The electronic device 110 of FIG. 10 may include one or more elements shown in FIG. 1. For example, the smart phone 110_1a may include the display device 10 shown in FIG. 1, the processor 12, the memory 13, and the power module 14 shown in FIG. 9. The smartphone 110_1a may further include a communication module and a battery device. Power provided from the battery device may be converted through the power module 14 and may be provided to the processor 12, the memory 13 and the display device 10. According to an embodiment of the present disclosure, the display device 10 applied to the smartphone 10_1a may further include the power module 14. The processor 12 and the memory 13 may be provided in a form of chips mounted on a motherboard, which is an external device, but the present disclosure is not limited thereto.

According to embodiments of the present disclosure, by adjusting the brightness and luminance of the displayed image with reference to the power consumption as the display panel is driven, the power consumption of the display device and the image display quality according to the power consumption may be efficiently adjusted.

In addition, according to embodiments of the present disclosure, by resetting the luminance value of image data with reference to the power consumption as the display panel is driven to and display an image based thereon, the display quality such as brightness and luminance for an image with low power consumption characteristics may be further improved.

It should be noted that effects of the present disclosure are not limited to those described above and other effects of the present disclosure will be apparent to those skilled in the art from the following descriptions.

At least one of the components, elements, modules or units (collectively “components” in this paragraph) represented by a block in the drawings, may be embodied as various numbers of hardware, software and/or firmware structures that execute respective functions described above, according to one or more example embodiments. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A display device comprising:
a display panel having a display area in which a plurality of pixels are arranged;
a gate driver configured to drive gate lines in the display area;
a data driver configured to drive data lines in the display area;
a timing controller configured to align input image data according to a resolution of the display area and control driving timings of the gate driver and the data driver; and
a data correction processor configured to obtain an average power consumption for image data in a preset unit of at least one frame, correct the input image data using luminance modulation data according to the average power consumption, and provide corrected image data to the data driver.

2. The display device of claim 1, wherein the data correction processor is configured to:
store image data for each frame in the preset unit of at least one frame, and obtain an average power consumption for the stored image data for each frame;
compare the obtained average power consumption with a reference power consumption to obtain a difference in power consumption, and select a gamma compensation curve and the luminance modulation data according to the difference in power consumption;
extract grayscale compensation threshold values according to the luminance modulation data and correct grayscale values of the image data for each frame using the grayscale compensation threshold values; and
provide the data driver with corrected image data for each frame per at least one horizontal line.

3. The display device of claim 1, wherein the data correction processor comprises:
a frame data alignment unit configured to align and store image data input from the timing controller in the preset unit of at least one frame; and
a power consumption comparison/analysis unit configured to obtain an average power consumption for image data for each frame stored in the frame data alignment unit and compare the obtained average power consumption with a power consumption per a preset reference period.

4. The display device of claim 3, wherein the power consumption comparison/analysis unit is configured to obtain a power consumption for at least one frame of the stored image data by using a formula or a look-up table, based on a maximum grayscale frequency, a minimum grayscale frequency, and an average grayscale value of the stored image data for each frame.

5. The display device of claim 4, wherein the power consumption comparison/analysis unit is configured to obtain, in real time or in a unit of a predetermined period, a difference between the obtained power consumption and the power consumption per the preset reference period, and wherein the power consumption per the preset reference period comprises a power consumption for at least one frame during which the display panel displays an image at a maximum luminance.

6. The display device of claim 3, wherein the data correction processor further comprises:
a luminance modulation data selection unit configured to select a gamma compensation curve and the luminance modulation data according to a difference in power consumption between the obtained average power consumption and the power consumption per the preset reference period, and output grayscale compensation threshold values according to the luminance modulation data;
a frame data correction unit configured to generate corrected image data for each frame by correcting grayscale values for image data of each frame stored in the frame data alignment unit using the grayscale compensation threshold values output from the luminance modulation data selection unit; and a corrected data output unit configured to provide the data driver with the corrected image data for each frame in a unit of at least one horizontal line.

7. The display device of claim 6, wherein the luminance modulation data selection unit is configured to select or maintain a reference gamma compensation curve based on the difference in power consumption being or maintained within a predetermined reference power consumption, and wherein the luminance modulation data selection unit is configured to select one of a plurality of gamma compensation curves that are set with respective grayscale compensation threshold values, by which a maximum luminance value and gamma compensation voltage values become lower, based on the difference in power consumption being greater than the predetermined reference power consumption.

8. The display device of claim 7, wherein the respective grayscale compensation threshold values of the plurality of gamma compensation curves are such that the maximum luminance value and the gamma compensation voltage values are lowered stepwise as the difference in power consumption becomes greater than the predetermined reference power consumption stepwise.

9. The display device of claim 7, wherein the data correction processor further comprises a compensation threshold storage unit configured to store the grayscale compensation threshold values, which are variably increased or decreased according to curvatures of the plurality of gamma compensation curves having different maximum luminance values.

10. The display device of claim 7, wherein the frame data correction unit is configured to correct the grayscale values for each frame by applying the grayscale compensation threshold values using a formula, and provide the corrected image data for each frame having the corrected grayscale values to the corrected data output unit.

11. A display device comprising:
a display panel having a display area in which a plurality of pixels are arranged;
a gate driver configured to drive gate lines in the display area;
a data driver configured to drive data lines in the display area;
a timing controller configured to align input image data according to a resolution of the display area and control driving timings of the gate driver and the data driver; and a data correction processor configured to obtain an average power consumption for image data of at least one frame and correct the input image data according to the average power consumption, wherein the data correction processor configured to obtain the average power consumption for the image data for each frame in a preset unit of at least one frame, and select luminance modulation data according to a difference between the average power consumption and a reference power consumption, and wherein the data correction processor is configured to correct grayscale values of the image data for each frame using the luminance modulation data, and provide the corrected image data for each frame to the data driver.

12. The display device of claim 11, wherein the data correction processor comprises:
a frame data alignment unit configured to align and store image data input from the timing controller in the preset unit of at least one frame; and a power consumption comparison/analysis unit configured to obtain an average power consumption for image data for each frame stored in the frame data alignment unit and compare the average power consumption with a power consumption per a preset reference period.

13. The display device of claim 12, wherein the power consumption comparison/analysis unit is configured to obtain a power consumption for at least one frame of the stored image data by using a formula or a look-up table, based on a maximum grayscale frequency, a minimum grayscale frequency, and an average grayscale value of the stored image data for each frame.

14. The display device of claim 12, wherein the data correction processor further comprises:
a luminance modulation data selection unit configured to select a gamma compensation curve and the luminance modulation data according to a difference in power consumption between the average power consumption and the power consumption per the preset reference period, and output grayscale compensation threshold values according to the luminance modulation data; a frame data correction unit configured to generate corrected image data for each frame by correcting grayscale values for each frame of the image data stored in the frame data alignment unit using the grayscale compensation threshold values output from the luminance modulation data selection unit; and a corrected data output unit configured to provide the data driver with the corrected image data for each frame in a unit of at least one horizontal line.

15. The display device of claim 14, wherein the luminance modulation data selection unit is configured to select or maintain a reference gamma compensation curve based on the difference in power consumption being or maintained within a predetermined reference power consumption, and wherein the luminance modulation data selection unit is configured to select one of a plurality of gamma compensation curves that are set with respective grayscale compensation threshold values, by which a maximum luminance value and gamma compensation voltage values become lower, based on the difference in power consumption being greater than the predetermined reference power consumption.

16. The display device of claim 15, wherein the respective grayscale compensation threshold values of the plurality of gamma compensation curves are such that the maximum luminance value and the gamma compensation voltage values are lowered stepwise as the difference in power consumption becomes greater than the predetermined reference power consumption stepwise.

17. The display device of claim 14, wherein the frame data correction unit is configured to correct the grayscale values of the image data for each frame by applying the grayscale compensation threshold values using a formula, and provide the corrected image data for each frame having the corrected grayscale values to the corrected data output unit.

18. An electronic device comprising a display device, wherein the display device comprises:
a display panel having a display area in which a plurality of pixels are arranged;
a gate driver configured to drive gate lines in the display area;
a data driver configured to drive data lines in the display area;
a timing controller configured to align input image data according to a resolution of the display area and control driving timings of the gate driver and the data driver; and a data correction processor configured to obtain an average power consumption for image data in a preset unit of at least one frame, correct the input image data using luminance modulation data according to the average power consumption, and provide corrected image data to the data driver.

19. The electronic device of claim 18, wherein the data correction processor is configured to:
store image data for each frame in the preset unit of at least one frame, and obtain an average power consumption for the stored image data for each frame;
compare the obtained average power consumption with a reference power consumption to obtain a difference in power consumption, and select a gamma compensation curve and the luminance modulation data according to the difference in power consumption; extract grayscale compensation threshold values according to the luminance modulation data and correct grayscale values of the image data for each frame using the grayscale compensation threshold values; and provide the data driver with corrected image data for each frame per at least one horizontal line.

20. The electronic device of claim 18, wherein the data correction processor comprises:
a frame data alignment unit configured to align and store image data input from the timing controller in the preset unit of at least one frame; and a power consumption comparison/analysis unit configured to obtain an average power consumption for image data for each frame stored in the frame data alignment unit and compare the obtained average power consumption with a power consumption per a preset reference period.
